(19) United States
(12) Patent Application Publication
(10) Pub. No.: US 2025/0189067 A1
(43) Pub. Date: Jun. 12, 2025

(54) TRACTION SYSTEM FOR MOVING A ROBOT AND ITS UMBILICAL CABLE INSIDE PIPELINES IMPLEMENTED IN A ROBOTIC SYSTEM, AND METHOD FOR MANUFACTURING AN ELASTIC CYLINDER WITH HELICAL PROJECTIONS FOR THE TRACTION SYSTEM

(71) Applicants: PETRÓLEO BRASILEIRO S.A. – PETROBRAS, Rio de Janeiro (BR); SERVIÇO NACIONAL DE APRENDIZAGEM INDUSTRIAL – SC/SENAI, Florianópolis (BR); SERVIÇO NACIONAL DE APRENDIZAGEM INDUSTRIAL – REGIONAL RS, Porto Alegre (BR); UPSENSOR DE DESENVOLVIMENTO LTDA – ME, São Leopoldo (BR); UNIVERSIDADE FEDERAL DO RIO GRANDE DO SUL - UFRGS, Porto Alegre (BR)

(72) Inventors: André Viegas WENTZ, São Leopoldo (BR); Andre Giacomini Dias CARMONA, São Leopoldo (BR); Hugo Francisco Lisboa SANTOS, Rio de Janeiro (BR); Frederico EGGERS, São Leopoldo (BR); Vinícius CABREIRA, São Leopoldo (BR)

(21) Appl. No.: 18/973,311

(22) Filed: Dec. 9, 2024

(30) Foreign Application Priority Data
Dec. 12, 2023 (BR) 1020230261230

(51) Int. Cl. F16L 55/32; B25J 9/00; B25J 9/06; B61B 13/10; B61C 11/00; B61C 13/00; F16L 101/30

(52) U.S. Cl. CPC F16L 55/32; B25J 9/0015; B25J 9/065; B61C 11/00; B61C 13/00; B61B 13/10; F16L 2101/30

(57) ABSTRACT

The present disclosure relates to embodiments of a traction system for moving a robot and its umbilical cable inside pipelines implemented in a robotic system and to embodiments of a method of manufacturing an elastic cylinder with helical projections for the traction system.

### FIELD OF THE DISCLOSURE

The present disclosure is part of the technical field of oil and gas, more specifically, it is related to the field of vessels, platforms, and rigs, and more specifically, it refers to the application of any type of intervention or inspection technique of the internal surfaces of hollow or cavernous bodies for oil production and the like.

### BACKGROUND OF THE DISCLOSURE

It is currently known that pipes and pipelines are used in various applications to transport fluids. In certain fluids, there may occur settling of heavy portions, sedimentation, accumulation of scale and other types of formations capable of causing obstructions. To eliminate these obstructions, maintenance procedures are necessary to restore the original performance of the pipe. Monitoring and maintenance of these pipelines requires the use of specialized tools, which, in the state of the art, are not yet capable of reaching the problematic region in cases where the distance to be covered is significantly large. Specifically in the oil production, long lines of rigid or flexible pipes are used to transport the oil produced from the oil well to the platform on the surface. In these cases, when an obstruction that cannot be removed by passive procedures occurs, a robotic intervention becomes the only viable option to remedy the situation. In order for a robotic tool to move inside an oil producing pipe, it needs, at the very least, to traction its own weight. In some cases, this robot is remotely piloted, with a cable connection between the unit and the controller. In cases where the robot's power must be sent from the controller unit, this cable is more complex and begins to restrict the robot's movement. In this scenario, the robot's locomotion system must be capable of exerting a significant traction force in order to move and drag the cable, also known as the umbilical cable. Since the surfaces that the robot can use to traction itself are smooth and lubricated by the transported fluid, an anchoring system is required that can attach itself to the pipe to traction the own weight of a robotic system and its umbilical cable.

Due to this configuration, one of the applications of the movement system for a robotic system uses at least two modules, one for temporary anchoring to the pipe wall and another to provide longitudinal translation, such as a linear actuator to provide movement of the unit by pulling the same from the front like a locomotive, for example. The system can also have three modules, where two anchoring modules are activated alternately, causing the actuator to alternately push and pull the rest of the system. Therefore, it is a problem for this type of system to specify an anchoring module for the robotic system.

In this way, among the solutions that provide more contact area, there are those that use an elastomeric element inflated radially by hydraulic or pneumatic pressure. This method provides a large contact area against the internal surface of the pipeline. Due to the larger contact area, this method mitigates the difficulties caused by irregularities in the pipeline surface and/or the low coefficient of friction between the surfaces. Since it is an elastomeric element, there is an applicable pressure limit due to the mechanical strength of the material itself, because when this limit is exceeded, damage can be caused to the elastomer. Therefore, it is a problem to find a construction form for this elastomer that provides resistance in the direction of movement, but without losing elasticity to accompany the variations in diameter and irregularities of the pipe.

Consequently, the low rigidity and low mechanical strength of the elastomeric element in its monolithic form also limit the force it is capable of providing to the movement system. The solutions that exist in the state of the art using this approach for anchoring only carry the robot's own weight and are not capable of tractioning an umbilical cable being dragged through kilometers of tubular lines that do not follow a linear trajectory.

Furthermore, another feature of an elastomeric radial anchoring system is that the deformation caused by longitudinal traction loads leads to the radial deformation of the elastomer, so that it detaches from the internal surface of the pipeline.

In this way, even if the above issues are solved, when used inside oil production pipes, this gripping system will encounter surfaces lubricated by oil, where the friction force alone is not sufficient to traction several ton-forces of resistance to the movement of an umbilical cable.

In view of this, the indiscriminate use of fibers in the elastomeric element causes a limitation of the deformation to expand radially and generate a broad contact surface against the internal surface of the pipeline. In this way, it is necessary to find a solution that allows the elastomer to expand elastically and radially with large deformations, sufficient for the elastomer to reach the diameter of the pipe where it is inserted, but still retaining sufficient mechanical strength to transmit large traction force in the longitudinal direction.

### STATE OF THE ART

In the state of the art, there are several proposals for traction systems to move a robot and its umbilical cable. It is noted that the application of reinforcing fibers in the elastomer itself is not something new, much less its alignment with the efforts. However, the systems in the state of the art present deficiencies when compared to the traction system of the present disclosure, since the system of the present disclosure discloses a constructive form that reconciles the sealing of the elastomeric cylinder to form a pressurized cavity, with the anchoring of the fibers to discharge the movement efforts in the robot chassis.

Patent BR1020190128542 document of the applicant itself, which describes the general state of the art, for example, discloses a robot launch system for use in oil and gas production wells. The disclosure is used for the introduction of robots that operate internally in flexible and rigid pipes, requiring the connection of the piping system to the developed equipment. After connection, and by handling the system valves, it is possible to introduce the robot into the pipeline.

However, the present disclosure differs from document BR1020190128542, because, in addition to referring to a different technology used, the disclosure of document BR1020190128542 is used for the introduction of robots that operate internally in flexible and rigid pipes, requiring the connection of the pipeline system to the developed equipment, which makes the system of document BR1020190128542 flawed if slight variations occur in the diameter of the pipe, preventing the self-locking necessary for the robot to be mounted, which does not happen in the solution proposed by the present disclosure, which has fibers in the elastomeric element limiting the deformation, radially expanding and generating a broad contact surface against the internal surface of the pipe. In addition, document BR1020190128542 does not use fibers that assist in anchoring to the central element, making it possible to discharge the traction efforts between the elastomer and the robot chassis, as well as the present disclosure.

In turn, document US20180313715A1, which describes the general state of the art, discloses a robotic system comprising two robots, wherein a mobile robot is used for pipelines inspection and is capable of inspecting complex-shaped pipe structures. Such complex tubular structures may have a wide range of internal diameters and may consist of horizontal and vertical tubular elements. In addition, internal obstacles may be encountered, such as pipeline bends and connections (T branches, Y branches) and any slope.

However, document US20180313715A1, unlike the present disclosure, is unable to provide sufficient mounting to withstand the forces required to traction the umbilical cable, since the contact area of the wheels with the umbilical is very small, a problem that the present disclosure solves, for example, by using flexible material of the cylinder that is also composed of reinforcement by fibers aligned longitudinally to its axis, capable of increasing the contact area and enabling the deformation of the material.

In document U.S. Pat. No. 6,672,222B2, which broadly protects a hydraulic system that transfers the traction force to the walls of the pipe through small wheels with ratchets, it is possible to identify the same technical problem mentioned above, wherein there is not sufficient mounting to withstand the forces required to traction the umbilical cable, since the contact area of the wheels with the flexible pipe is also very small.

Document JP2021033092A teaches a mounting way with features similar to those of the present disclosure. It proposes an external elastic cylinder and an internal bellow to enable the creation of a cavity that can be pressurized to increase the diameter of the external elastic cylinder enough for it to touch the walls of the pipe. This solution provides more contact area, as it mentions the use of fibers in the external elastic cylinder as a way to increase the rigidity and strength of the elastomer in the direction of the efforts, without compromising the elasticity for the increase in radial diameter. However, to successfully traction an umbilical cable in a flexible pipe, the disclosure of document JP2021033092A still needs features that are not taught therein, such as the freedom of translation of the elastomer in relation to the couplings of the modules and the protrusions. Furthermore, a limitation presented by document JP2021033092A is that whenever the elastomer is pressurized and increases in diameter, its ends must inevitably move, shortening its length. If the weight of the systems connected to the sides of this module is too great, it will not be able to drag these items and take the configuration that allows the elastomer to reach the pipe and provide the mounting.

Unlike document JP2021033092A, the aforementioned problem does not occur in the present disclosure, as the elastomer shares only one attachment with the primary structure of the system, leaving one of the sides loose. The compromise that this causes is that it can only be used in one direction of movement of the robot. The other deficiency of this document of prior art is that, despite providing a large contact area with the pipe, it will depend only on the friction between the surfaces to generate the necessary mounting force. However, in pipes contaminated by oil, the friction between the surfaces is very low due to the lubricating power of the oil, and, therefore, other means of increasing the transmitted force are necessary, such as the use of projections on the surface of the elastomer so that they fit into the gaps in the interlocked structure of the flexible pipe. Additionally, document JP2021033092A does not teach how the fibers should be anchored to the central element, in order to discharge the traction efforts between the elastomer and the robot chassis.

### BRIEF DESCRIPTION OF THE DISCLOSURE

The present disclosure relates to embodiments of a traction system for moving a robot and its umbilical cable inside pipelines implemented in a robotic system, comprising: a cylindrical anchoring module sized to be inserted inside a pipe (10); a central body; a cylinder (1) of flexible material anchored and sealed around the central body, forming a toroidal cavity; wherein one end of the cylinder is fixed (7) to the central body and an opposite end is free (8) to move axially, wherein the free end (8) has a sliding seal in its attachment and translates during the pressurization of the cavity, keeping a robot, its load and an umbilical connection immobile during anchoring to the internal surface of the pipe (10); the flexible material of the cylinder (1) is composed of any elastic material; wherein the flexible material of the cylinder (1) is further composed of a reinforcement by fibers aligned longitudinally (3) to its axis capable of coupling with the elastomeric matrix; wherein the fibers in the elastomeric element limit the deformation, radially expanding and generating a broad contact surface against the internal surface of the pipe; when an internal pressure is applied, the cylinder (1) deforms towards the internal wall of the pipe, generating a contact pressure against the same and, with this, a normal force, resulting in a proportional friction force; additionally, the elastic cylinder (1) has helical projections (4) on its external surface, which, when expanding, fit into the grooves of the interlocked metal reinforcement of the flexible pipe (10); wherein, additionally, the elastic cylinder (1) must be assembled on a suitable mechanical structure capable of providing the restriction of the fixed end (7) of the cylinder (1), providing a longitudinal sliding guide for the free end (8) of the cylinder (1). The cylindrical anchoring module has a length compatible with the curves and derivations existing in the pipe. The flexible material of the cylinder (1) is composed of any elastic material, preferably elastomers with high stretching capacity, preferably elastomers resistant to contact with hydrocarbons such as nitrile rubbers and fluoroelastomers. The flexible material of the cylinder (1) is also preferably composed of reinforcement by fibers aligned longitudinally (3) to its axis capable of coupling with the elastomeric matrix, which may be carbon fibers, glass fibers, polyethylene fibers, aramid fibers or others. The robotic system comprises providing a hydraulic or pneumatic pressure; and controlling the moment and intensity of application of said pressure.

The present disclosure further relates to a method of manufacturing an elastic cylinder (1) with helical projections (4) for a traction system as defined in claim 1, which comprises the steps of: (a) starting the manufacturing as a rubber blanket (9); (b) winding said rubber blanket (9) on a fiber positioning device (13); (c) placing the anchoring ring (6) over the fibers; (d) applying a core of the helical projection (5) to the elastic cylinder (1); (e) covering the anchoring ring (6) with fibers that are cut and fixed to another support device, a Fiber Support Ring (17); (f) repeating the previous steps for the other side; (g) folding the portion of the blanket that loops the anchoring ring (6) forming the helical projection (4); (h) covering the elastic cylinder (1) with a mold and applying pressure to consolidate the layers of the rubber blanket (9). In step (a), the rubber blanket (9) preferably has a rectangular shape. The contour of the elastic cylinder (1) is pre-established based on a simulation of the development of the final geometry. Said developed shape also has on two of its opposite edges, specifically those that join to form the cylinder (1), a sequence in the shape of S or Z, where the meeting of this geometry forms a joint without gaps. The fiber positioning device (13) has two domes with fins) aligning the longitudinal fibers (3) on its external surface of the rubber blanket (9). In step (d), a preferred way to produce the core of the helical projection (5) is to use a rubber extruder to produce the profile of the core (5), but without the use of heat, avoiding vulcanizing the elastomer. To apply said core (5), a spiral-shaped template (15) is used with a helix pitch equivalent to the pitch of the interlocked reinforcement helix of the flexible pipe (10) where the system will be anchored. Said spiral template (15) ensures that the positioning of the helical projection (4) will be perfectly aligned with the interstices (12) of the flexible pipe (10). In step (c), a preferred way of manufacturing the anchoring ring (6) is divided into curved links (16) that are subsequently joined by pins or screws. It is preferably obtained with autoclaves, by applying pressure to consolidate the fibers and temperature to crosslink the rubber matrix, resulting in an elastomeric composite.

### BRIEF DESCRIPTION OF THE FIGURES

In order to complement the present description and obtain a better understanding of the features of the present disclosure, and according to an embodiment thereof, a set of figures is presented in attachment, where its preferred embodiment is represented in an exemplary, although not limitative, manner.

In FIG. 1, there is represented a view of the elastic cylinder (1) in the rest and pressurized configuration, that is, the elastic cylinder in the expanded configuration (2), according to an embodiment of the present disclosure.

FIG. 2 is a view of the elastic cylinder (1) with helical projection (4), according to an embodiment of the present disclosure.

In FIG. 3, there is represented the flexible oil production pipe (10), according to an embodiment of the present disclosure.

FIG. 4 is a view of the interstice (12) of the interlocked casing (11) used in flexible pipes (10), according to an embodiment of the present disclosure.

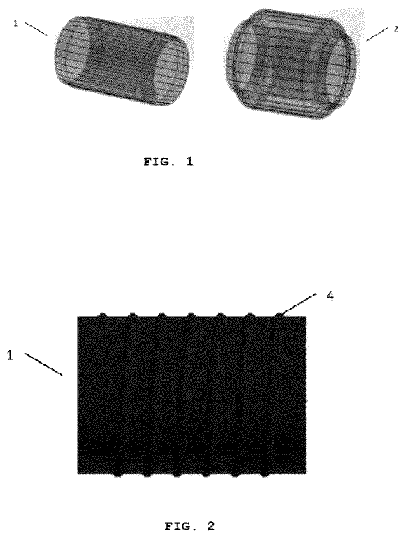

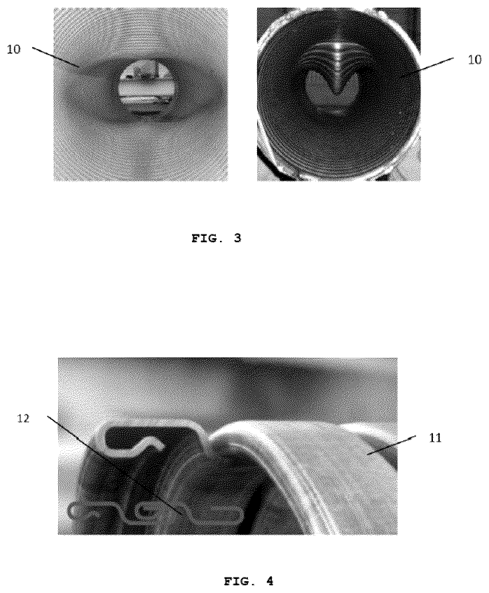

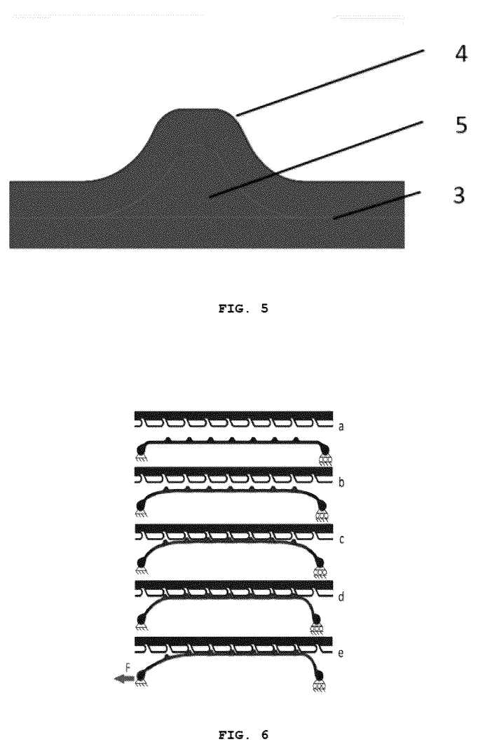

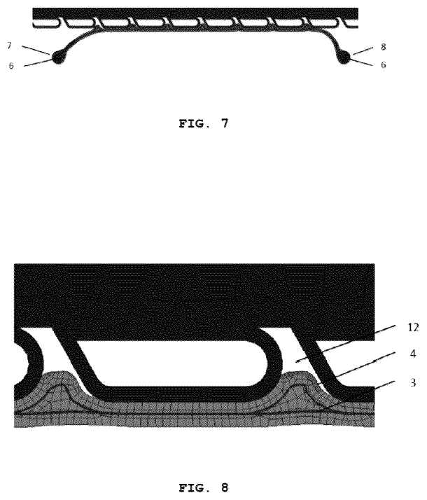

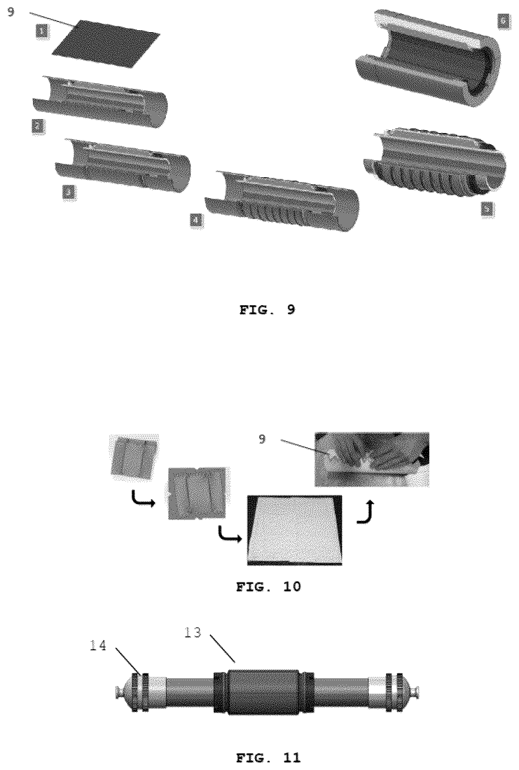

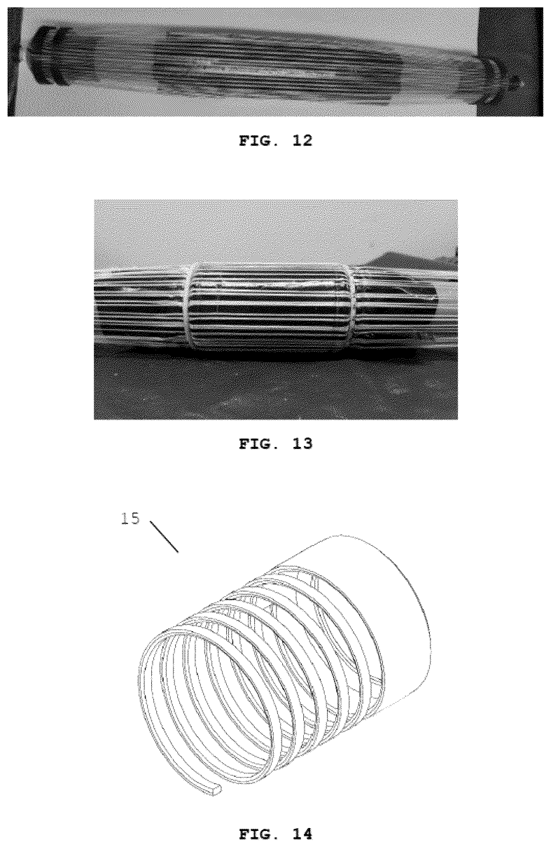

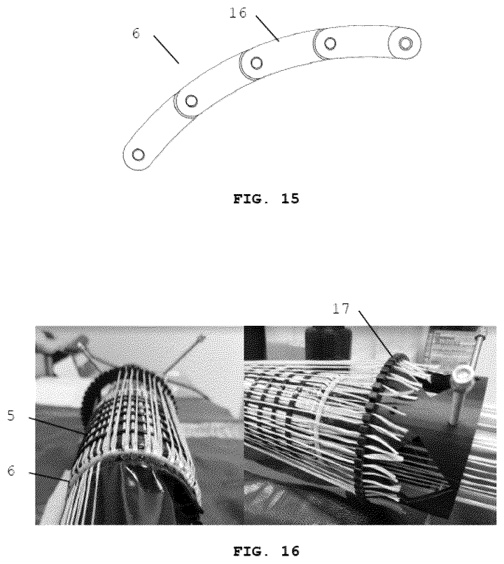

In FIG. 5, there is represented a detailed view of the fiber reinforcement (3) in the helical projection (4) and the core of the helical projection (5), according to an embodiment of the present disclosure.

In FIG. 6, there are represented the stages of pressurization of the elastic cylinder and traction reaction, according to an embodiment of the present disclosure.

In FIG. 7, there is represented a cross-sectional view of the elastic cylinder (1), the fiber anchoring ring (6), a fixed end of the cylinder (7), a free end of the cylinder (8), in which the elastic cylinder (1) is synchronizing its helical projections (4) in the interlocked casing (11), according to an embodiment of the present disclosure.

In FIG. 8, there is represented a detailed view of the fiber reinforcement (3) in the helical projection (4), the interstice of the interlocked casing (12) and its interaction with the interlocked reinforcement of the flexible pipe (10), according to an embodiment of the present disclosure.

In FIG. 9, there is represented the sequence of steps in the method for manufacturing the elastic cylinder with helical projections, according to an embodiment of the present disclosure.

In FIG. 10, there is represented the sequence of steps for obtaining the preform of the rubber blanket (9), according to an embodiment of the present disclosure.

In FIG. 11, there is represented the fiber positioning device (13) that uses domes with fins (14) to position the continuous and longitudinal fiber reinforcements (3), according to an embodiment of the present disclosure.

In FIG. 12, there is represented the end of the step of applying the continuous and longitudinal fibers (3) on the rubber blanket (9) using the fiber positioning device (13), according to an embodiment of the present disclosure.

In FIG. 13, there is represented the image of the application of the fiber anchoring rings (6) immediately before the application of the core of the helical projection (5), according to an embodiment of the present disclosure.

In FIG. 14, there is represented the Spiral template (15) used to position the core (5) of the helical projection (4), according to an embodiment of the present disclosure.

In FIG. 15, there is represented a preferred construction form of the Fiber anchoring ring (6), according to an embodiment of the present disclosure.

In FIG. 16, there is represented a view of the fiber anchoring rings (6), the core of the helical projection (5) and another support device called Fiber Support Ring (17), according to an embodiment of the present disclosure.

### DETAILED DESCRIPTION OF THE DISCLOSURE

The present disclosure relates to a traction system for moving a robot and its umbilical cable inside pipelines, said traction system being implemented in a robotic system. Additionally, the disclosure further describes a method for manufacturing an elastic cylinder (1) with helical projections (4) for said traction system. Specifically, the present disclosure solves the problems mentioned above by means of a cylindrical anchoring module sized for insertion into oil production pipes and the like, with a length compatible with the curves and derivations existing in these types of pipelines.

The present disclosure uses a cylinder (1) made of flexible material, anchored, and sealed around a central body, forming a toroidal cavity. One end of the cylinder is fixed (7) to the central body, while the opposite end is free (8) to move axially. The free end (8) has a sliding seal in its attachment, so that the cavity is pressurized without leaks, when it translates in linear motion. The flexible material of the cylinder is manufactured using fibers aligned longitudinally to its axis as reinforcement, limiting its deformation in the direction of movement, but without restricting the tangential deformation necessary for the cylinder (1) to expand until it makes contact with the pipe. The construction material of the flexible cylinder (1) can be any elastic material, preferably elastomers with a high stretching capacity, preferably elastomers resistant to contact with hydrocarbons such as nitrile rubbers and fluoroelastomers.

Specifically, when an internal pressure is applied, the cylinder (1) deforms towards the internal wall of the pipeline, generating a contact pressure against the same, and, with this, a normal force results in a proportional friction force. In this way, the disclosure solves the difficulty of providing a large contact area for mounting and the difficulty of lack of compliance of the metallic solutions that do not have sufficient elasticity to follow the dimensional variations of the pipe.

Consequently, to solve the difficulty of withstanding high pressures and transferring high efforts through the elastomer, the present disclosure discloses the application of a reinforcement by functionalized fibers (3) for coupling with the elastomeric matrix, and carbon fibers, glass fibers, polyethylene fibers, aramid fibers or others may be used. Preferably, the reinforcement is made of aramid fiber, as this material allows greater deformation before rupture, helping to transfer more load between the matrix and the available fibers, before any of them reach the rupture limit. The fiber bundles are preferably applied in the middle of the elastomer layer, with their ends being anchored to the central structure of the module. This anchoring may be in the form of a loop wrapped around a ring concentric to the module. Another possible form is to leave the fibers outside the rubber blanket (9) of the external ring and make individual loops for each fiber on a pin in the central structure. Furthermore, another preferred way of anchoring the fibers can be obtained by leaving the ends of the fiber outside the rubber blanket (9), assembling anchors on these ends, and resining the ends to form a region that can be fixed by other methods to the central structure of the module.

To solve the problem of the low friction coefficient between the elastomer and the surface of the pipe caused by the natural lubrication of oil, the present disclosure proposes the application of projections on the external surface of the elastic cylinder (1), which, when expanding, fit into the grooves of the interlocked metal reinforcement of the flexible pipe (10). These projections are preferably helical, in order to maximize the contact. Like a timing belt, this fit allows the application of efforts much greater than those that can be obtained with friction force alone.

The helical projections are a feature that increases the traction force that the flexible material is capable of exerting. However, this force can be even greater if the helical projections have the constructive form represented in FIG. 5. In this image, it is possible to see that the fiber bundle contained in the rubber blanket (9) is divided into two, one following along the flexible component and the other following the helical projection (4). This feature stiffens the projection, allowing it to transmit greater effort to the pipe. The fibers used in the contour of the projection core (5) can be carbon fibers, glass fibers, aramid fibers or other fibers. In an embodiment of the disclosure, the use of aramid fibers is ideal because this material is more flexible and forms the contour without the risk of breaking, as occurs with fibers made of ceramic materials.

Additionally, as shown in FIGS. 6, 7 and 8, it is noted that the improvements proposed by the present disclosure were numerically validated with models based on the Finite Element Method. These studies proved that the friction force of the elastomer with the surface of the pipeline alone is not enough to generate the necessary traction reaction. The main reason for this phenomenon to occur is the low coefficient of friction between the surfaces in the condition in which oil production pipes are found when they are obstructed.

In this condition, the friction coefficient is equal to or less than 0.1; so, less than one tenth of the normal force obtained with the internal pressure of the elastic cylinder (1) is transformed into traction force. The simulations demonstrated the limitation of friction, with slippage observed between the surfaces at loads lower than 50% of the value required to move the robot through the oil production lines. By adding the helical projections, the slippage limitation was overcome, and the load obtained was 80% higher than the results without the projections.

Basically, the elastic cylinder (1) of the present disclosure begins its manufacture as a rubber blanket (9), in the shape of a rectangle. Its contour is pre-established based on a simulation of the final geometry's development. This developed shape also has on two of its opposite edges, specifically those that join to form the cylinder (1), a sequence in the shape of an S or Z, where the meeting of this geometry forms a joint without gaps. This detail can be seen in FIG. 10. This construction way increases the strength of the rubber in its joint. The rubber blanket (9) is then winded onto the fiber positioning device (13) seen in FIG. 11. This device (13) has two domes with fins (14) necessary to align the longitudinal fibers (3) on its the external surface of the rubber blanket (9). Next, the anchoring ring (6) is placed over the fibers and the core of the helical projection (5) is applied to the elastic cylinder (1). A preferred way to produce the core of the helical projection (5) is to use a rubber extruder to produce the core profile (5), but without using heat, to avoid vulcanizing the elastomer. To apply this core (5), a spiral-shaped template (15) is used with a helix pitch equivalent to the helix pitch of the interlocked reinforcement of the flexible pipe (10) where the system will be anchored. The spiral template (15) is seen in FIG. 14 and ensures that the positioning of the helical projection (4) will be perfectly aligned with the interstices (12) of the flexible pipe (10). A preferred form of manufacturing the anchoring ring (6) is divided into curved links (16) that are subsequently joined by pins or screws. In FIG. 15 we see a detailed section of the links that form the anchoring ring (6) in a preferred form of the disclosure. In this preferred form, the ring (6) provides rigidity for anchoring the fibers, but flexibility to receive internal components necessary for assembling and sealing the system. And then it is covered by the fibers that are cut and fixed to another support device seen in FIG. 16, called Fiber Support Ring (17). The process is repeated for the other side and then the portion of the blanket that loops the anchoring ring (6) is folded, forming the helical projection (4). After this step, a mold covers the elastic cylinder (1), and pressure is applied to consolidate the layers of the rubber blanket (9). This method is obtained with autoclaves, by applying pressure to consolidate the fibers and temperature to crosslink the rubber matrix, resulting in an elastomeric composite.

The fixed end (7) is attached to the robot structure and is the path of the load between the surface of the pipe and the robot. The other end is free (8) and has the function of allowing the elastic cylinder (1) to deform from its resting configuration (1) to the expanded configuration (2) without the undesirable consequence of simultaneously tractioning the robot. The expansion of the elastic cylinder (1) is done by applying pressure inside the cylinder (1), which can be pneumatic or hydraulic.

In general terms, the feature taught of leaving one of the sides (8) of the elastic cylinder (1) free to translate during the pressurization of the cavity provides the advantage of not causing movement of the robot, its load and umbilical connection during the act of anchoring to the internal surface of the pipe. This decouples the anchoring and movement activities, improving control over the movement and allowing the anchoring of the robotic system to be maximized.

Among the advantages found, the present disclosure increases the capacity of robotic units to move inside pipes, allowing maintenance inspections to be carried out that bring greater reliability and safety to their operation, in addition to reducing the environmental impact associated with possible pipe ruptures.

1. A traction system for moving a robot and its umbilical cable inside pipelines implemented in a robotic system, the traction system comprising:
a cylindrical anchoring module sized to be inserted inside a pipe;
a central body;
a cylinder of flexible material anchored and sealed around the central body, forming a toroidal cavity;
wherein one end of the cylinder is fixed to the central body and an opposite end is free to move axially, wherein the free end has a sliding seal in its attachment and translates during the pressurization of the cavity, keeping a robot, its load and an umbilical connection immobile during anchoring to the internal surface of the pipe; and
the flexible material of the cylinder is composed of any elastic material;
wherein the flexible material of the cylinder is further composed of a reinforcement by fibers aligned longitudinally to its axis capable of coupling with the elastomeric matrix;
wherein the fibers in the elastomeric element limit the deformation, radially expanding and generating a broad contact surface against the internal surface of the pipe;
when an internal pressure is applied, the cylinder deforms towards the internal wall of the pipe, generating a contact pressure against the same and, with this, a normal force, resulting in a proportional friction force;
additionally, the elastic cylinder has helical projections on its external surface, which, when expanding, fit into the grooves of the interlocked metal reinforcement of the flexible pipe;
wherein, additionally, the elastic cylinder must be assembled on a suitable mechanical structure capable of providing the restriction of the fixed end of the cylinder, providing a longitudinal sliding guide for the free end of the cylinder.

2. The system according to claim 1, wherein the cylindrical anchoring module has a length compatible with the existing curves and derivations in the pipe.

3. The system according to claim 1, wherein the flexible material of the cylinder is composed of any elastic material, preferably elastomers with high stretching capacity, preferably elastomers resistant to contact with hydrocarbons such as nitrile rubbers and fluoroelastomers.

4. The system according to claim 1, wherein the flexible material of the cylinder is further composed, preferably, of reinforcement by fibers aligned longitudinally to its axis capable of coupling with the elastomeric matrix, which may be carbon fibers, glass fibers, polyethylene fibers, aramid fibers or others.

5. The system according to claim 1, wherein the robotic system additionally comprises:
providing a hydraulic or pneumatic pressure; and
controlling the moment and intensity of application of said pressure.

6. A method for manufacturing an elastic cylinder with helical projections for a traction system as defined in claim 1, further comprising the steps of:
a. starting the manufacturing as a rubber blanket;
b. winding said rubber blanket on a fiber positioning device;
c. placing the anchoring ring over the fibers;
d. applying a core of the helical projection to the elastic cylinder;
e. covering the anchoring ring with fibers that are cut and fixed to another support device, a Fiber Support Ring;
f. repeating the previous steps for the other side;
g. folding the portion of the blanket that loops the anchoring ring forming the helical projection;
h. covering the elastic cylinder with a mold and apply pressure to consolidate the layers of the rubber blanket.

7. The method according to claim 6, wherein step (a), the rubber blanket has a rectangular shape.

8. The method according to claim 6, wherein the contour of the elastic cylinder is pre-established based on a simulation of the development of the final geometry.

9. The method according to claim 8, wherein the developed shape also has, on two of its opposite edges, specifically those that join to form the cylinder, a sequence in the shape of S or Z, and wherein the meeting of this geometry forms a joint without gaps.

10. The method according to claim 6, wherein the fiber positioning device has two domes with fins aligning the longitudinal fibers on its external surface of the rubber blanket.

11. The method according to claim 6, wherein step (d), a preferred way to produce the core of the helical projection is to use a rubber extruder to produce the core profile, but without the use of heat, thus avoiding vulcanizing the elastomer.

12. The method according to claim 11, wherein to apply the core, a spiral-shaped template is used with a helix pitch equivalent to the pitch of the interlocked reinforcement helix of the flexible pipe where the system will be anchored.

13. The method according to claim 12, wherein the spiral template ensures that the positioning of the helical projection will be perfectly aligned with the interstices of the flexible pipe.

14. The method according to claim 6, wherein step (c), a form of manufacturing the anchoring ring is divided into curved links that are subsequently joined by pins or screws.

15. The method according to claim 6, wherein obtaining with autoclaves occurs, by applying pressure to consolidate the fibers and temperature to crosslink the rubber matrix, resulting in an elastomeric composite.
